(19) United States
(12) Patent Application Publication
(10) Pub. No.: US 2007/0278020 A1
(43) Pub. Date: Dec. 6, 2007

(54) Power backup for single and multiple power grid systems

(76) Inventors: Shaun L. Harris, Richardson, TX (US); Christian L. Belady, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/444,931

(22) Filed: Jun. 1, 2006

(51) Int. Cl. G08C 21/00

(52) U.S. Cl. 178/18.01

(57) ABSTRACT

A system comprising a plurality of power supplies coupled to a power grid via multiple connections. The system also comprises a connector coupled to one of the connections via a backup connection. If the system receives power from no more than one power grid, the connector couples the backup connection to a backup power supply. If the system receives power from multiple power grids, the backup connection does not carry a substantial electrical current.

### BACKGROUND

Electronic devices, such as personal computers, servers and printers, require power. The power needed by an electronic device may be drawn from one or more power supplies housed within the electronic device. The power supplies, in turn, may each draw power from a power grid, typically via a wall outlet. A power grid comprises a network of power lines and associated equipment used to transmit and distribute electricity over a geographic area.

For any of a variety of reasons (e.g., a fault condition), one or more of the power supplies or the power grid may fail, thus leaving the electronic device with insufficient power to operate properly and possibly damaging the electronic device. Accordingly, such electronic devices may be equipped with power redundancy, whereby additional power supplies are housed within an electronic device and coupled to more than one power grid. Should one or more of the power supplies or power grids fail, one or more of these additional power supplies are activated to ensure that the electronic device is provided with enough power to maintain proper operation. However, equipping an electronic device with power redundancy entails occupying an undesirably large amount of volume within the electronic device.

### BRIEF DESCRIPTION OF THE DRAWINGS

For a detailed description of the disclosed embodiments, reference will now be made to the accompanying drawings in which:

FIG. 1a shows a block diagram of a power supply system equipped with power redundancy in accordance with embodiments of the invention;

FIG. 1b shows a block diagram of a distribution control assembly in the power supply system of FIG. 1a, in accordance with embodiments of the invention;

FIG. 2 shows another block diagram of another power supply system equipped with power redundancy in accordance with embodiments of the invention; and

FIG. 3 shows a flow diagram of a method used to construct the power supply systems of FIGS. 1a, 1b and 2, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. The embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment.

Power supply configurations for electronic devices may be application-specific. For example, a server may be supplied with power using a configuration that depends on the purpose of the server. If the server is used to run a commercial Internet Website, then a server failure may cost a business substantial amounts of revenue. For this reason, it is desirable to ensure that the server functions without interruption. Accordingly, the server may be powered with a dual power grid configuration. In a dual power grid configuration, the server is provided with power from two power grids, each of which provides power to multiple power supplies within the server. If one of the server power supplies fails, or if one of the power grids fails, then the server is still provided with enough power from at least one remaining power grid such that server performance is not interrupted.

However, maintaining a dual power grid can be costly. Thus, if the server is used for less critical purposes, such as intra-office electronic mail, then maintaining a dual power grid configuration may be unnecessary. In such cases, a single power grid configuration may suffice. In a single power grid configuration, the server is provided with power from one power grid, which provides power to multiple power supplies within the server. If one of the power supplies fails, then the remaining power supplies are still able to provide enough power to the server. However, if the single power grid itself fails, then the server is no longer provided with power, and the server shuts down.

In the past, power supply systems for single power grid applications and multiple power grid applications (e.g., dual power grid applications) have been manufactured separately. Separately manufacturing such power supply systems is inefficient in terms of manufacturing time and costs. Accordingly, described herein are embodiments of a power supply system that may adaptively be used in conjunction with both single and/or multiple power grid applications. Because the embodiments of the power supply system disclosed herein are substantially similar, manufacturing costs are less than those of other power supply systems. Furthermore, because the embodiments integrate single and multiple power grid functionality, fewer power supplies are required in single and/or multiple power grid applications to establish redundancy. Thus, the embodiments occupy less space in electronic devices than would other power supply systems.

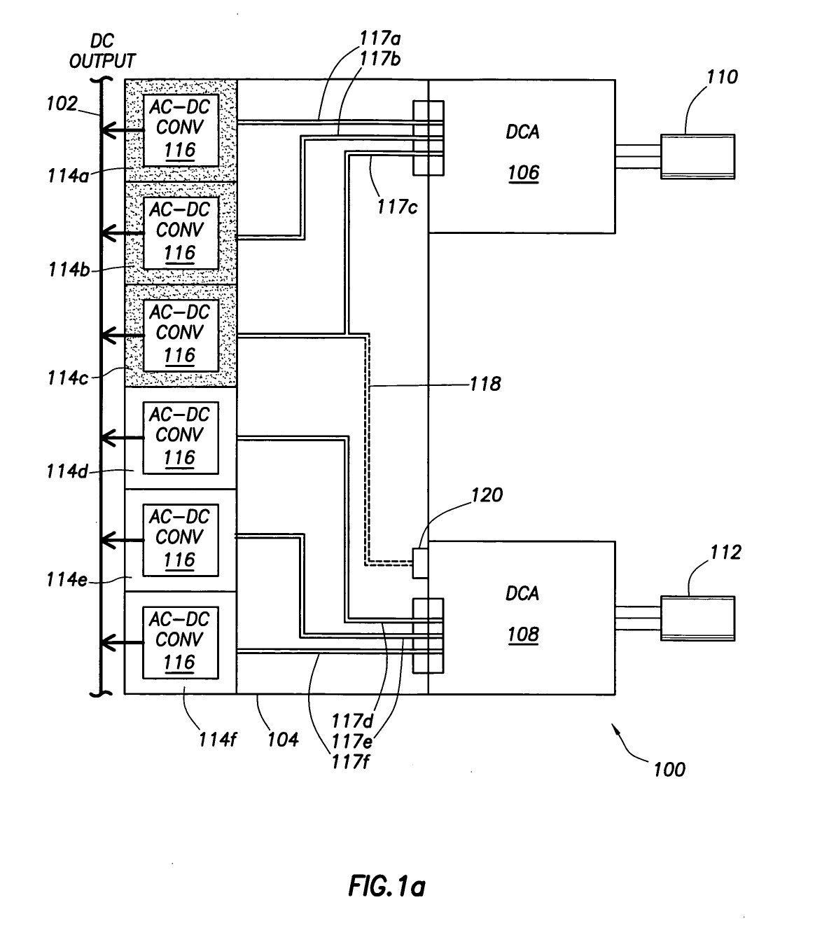

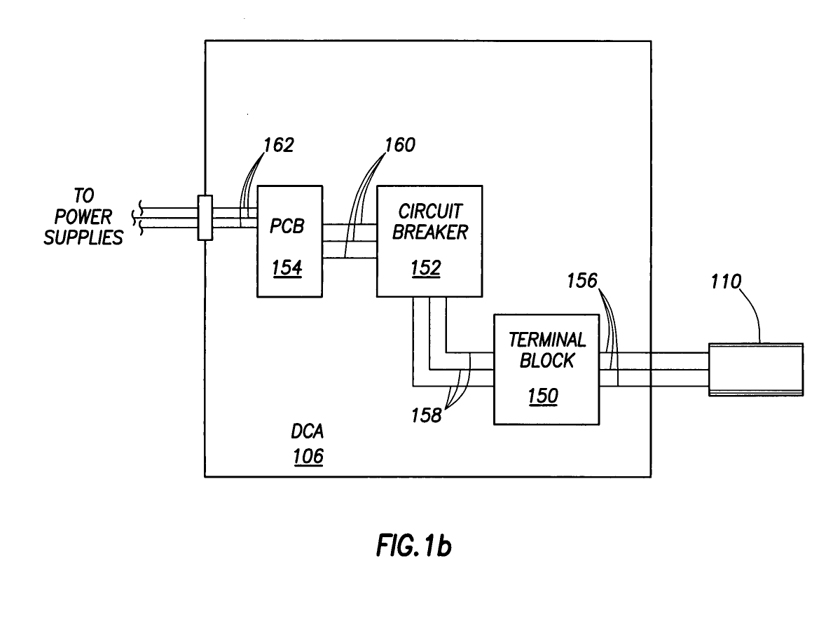

An illustrative embodiment of the power supply system is shown in FIG. 1a. Specifically, FIG. 1a shows a power supply system 100 comprising a direct current (DC) output line 102, a power chassis 104, distribution control assemblies (DCAs) 106, 108 and power grid connections 110, 112. The power chassis 104 is coupled to a plurality of power supplies 114a-114f, although the scope of disclosure is not limited to any particular number of power supplies. In at least some embodiments, the chassis 104 comprises a printed circuit board (PCB), although the scope of disclosure is not limited to a PCB and instead may comprise a chassis 104 that takes the form of some other suitable device. One or more of the power supplies 114a-114f may comprise alternating current (AC) to direct current converters (AC-DC converters) 116. In at least some embodiments, at least one of the power grid connections 110, 112 provides a three phase power input, but in other embodiments, one or more of the power grid connections 110, 112 may provide a different type of power input (e.g., a single phase input).

The DCAs 106, 108 may be used to adapt power received from power grid connections 110, 112 for use in the system 100. For instance, if the power grid connection 110 supplies three phase power, the DCA 106 may be used to “strip” the three phase input power into three one phase power connections 117a-117c, as shown. Similarly, if the power grid connection 112 supplies three phase power, the DCA 108 may be used to strip the three phase input power into three one phase power connections 117d-117f. Power connections 117a-117c are coupled to power supplies 114a-114c, respectively. Likewise, power connections 117d-117f are coupled to power supplies 114d-114f, respectively. One of the power connections 117a-117f is coupled to port 120 using power connection 118. In FIG. 1a, power connection 118 is coupled to power connection 117c, although the scope of disclosure is not limited as such. In the embodiment of FIG. 1a, the power connection 118 is not coupled to any of the power connections 117d-117f within the DCA 108. One purpose of the power connection 118 is disclosed further below.

FIG. 1b shows an illustrative embodiment of the DCA 106. The DCA 108 may be implemented in a manner similar to the DCA 106. In particular, FIG. 1b shows the DCA 106 comprising a terminal block 150, a circuit breaker 152 and a PCB 154. The DCA 106 receives power from the power grid 110, for example, in three phase form or any other suitable form. The power received from the power grid 110 is input into the terminal block 150 via connections 156. The power input into the terminal block 150 is output from the terminal block 150 via connections 158 into the circuit breaker 152 which, in turn, outputs the power via connections 160. In case the current delivered to the circuit breaker 152 via connections 158 exceeds a predetermined threshold, the circuit breaker 152 de-couples the connections 158, 160 from each other, thus protecting the PCB 154 from damage. The connections 160 are input into PCB 154, which PCB 154 comprises circuitry that can convert the power delivered via connections 160 from one form into another.

For example, assuming the power delivered by connections 160 into the PCB 154 is three phase power, the PCB 154 may convert the three phase power into three one phase power lines. The scope of disclosure is not limited to converting any particular type of power into another type of power; the PCB 154 converts power as desired. Regardless of the manner in which the power is converted, the PCB 154 outputs the converted power via connections 162. These connections 162 may couple to the power supplies of FIG. 1a, for instance, via the connections 117a-117c. Although the power connections of FIG. 1b (e.g., connections 156, 158, 160, 162) are shown in triads, the scope of disclosure is not limited as such. In at least some embodiments, the DCAs 106, 108 are transformer-based, although other embodiments may comprise different types of DCAs.

Referring again to FIG. 1a, in operation, the power chassis 104 is provided with power from power grids 110, 112. The power provided by the power grids 110, 112 may be AC power, DC power or a combination thereof. The power supplied by DCAs 106, 108 may be allocated among the power supplies as configured by a manufacturer and in any suitable manner. For example, in some embodiments, 25% of the power supplied via the DCA 106 may be allocated to each of power supplies 114a, 114b via power connections 117a, 117b, respectively. The remaining 50% of received power may be allocated to the power supply 114c via power connection 117c. In other embodiments, the power provided by the DCA 106 may be allocated equally among the power supplies 114a-114c, each power supply 114a-114c receiving approximately one third of the power received from the power grid 110. In such embodiments where the power supplies receive equal amounts of power, each power supply may comprise a forced current sharing circuit and a current share pin, neither of which are specifically shown. The current share pin is a control pin that can activate the forced current sharing circuit within each power supply. This circuit electronically forces all power supplies with current share pins tied together to share power equally. Thus, for example, each of the power supplies 114a-114c may comprise current share pins that are coupled together, thereby equally distributing power among the three power supplies 114a-114c. The scope of disclosure is not limited to any specific power allocation policy for the system 100. For instance, the power allocation policy for the power supplies 114a-114c may be the same or different for the power supplies 114d-114f. Regardless of the power allocation policy, once the power is provided to the power supplies 114a-114f, AC-DC converters 116 in the power supplies 114a-114f are used to convert AC power to DC power, if applicable. In other embodiments, DC power may be converted to AC power, AC power may be converted to a different AC power with a different voltage and/or frequency, and/or DC power may be converted to DC power with a different voltage and current. Power output by the power supplies 114a-114f is provided to DC output line 102, whereby the power is transferred and used as needed.

The illustrative embodiment of the power chassis 104 shown in FIG. 1a may be used in dual power grid applications. In the case that a power supply 114a-114f fails, power is automatically reallocated by the current share pins in the power supplies and by a corresponding DCA 106, 108. For instance, if the power supply 114b fails, then the power previously allocated to power supply 114b (e.g., 25% of the available power) is reallocated to power supplies 114a, 114c (e.g., 114a, 114b each receive an additional 12.5% of the total power). In the case that a power grid fails, the remaining power grid still provides enough power for the system 100 to continue operating properly. For instance, in case the grid connection 110 fails, the grid connection 112 is still functioning, so that the power supply to DC output line 102 is uninterrupted. Because the system 100 requires power from a minimum of three power supplies, in case the grid 110 fails, the power supplies 114d-114f coupled to grid 112 are sufficient for the system.

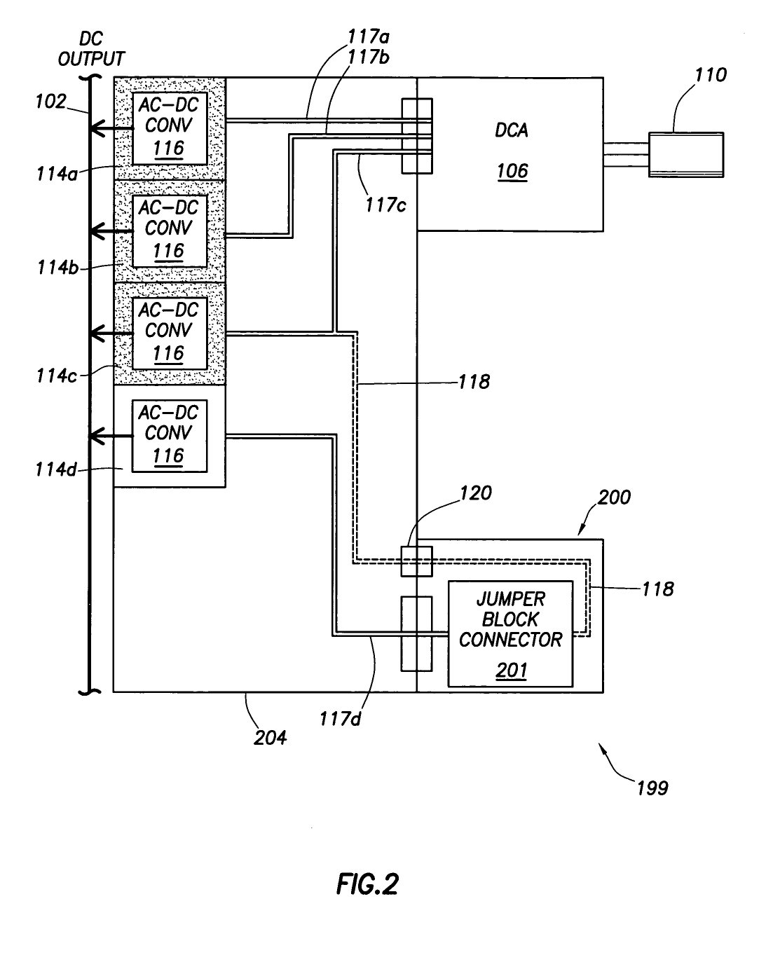

System 199 shown in FIG. 2 is used in single power grid applications. The system 199 is substantially similar to the system 100 of FIG. 1a, except for the removal of power supplies 114e, 114f and the replacement of DCA 108 with a jumper block 200 comprising a jumper block connector 201. The power connection 118 is coupled to port 120, which couples the power connection 118 to the power connection 117d via jumper block connector 201. Assume the system 199 requires a minimum of three active power supplies to operate properly. In operation, power (e.g., AC and/or DC power) is provided from power grid connector 110 to the DCA 106. Power from the DCA 106 is allocated among the power supplies 114a-114d as configured by the power allocation policy of the system 199. For example, each power supply 114a-114d may receive 25% of the power delivered by the DCA 106. In the case that one of the power supplies 114a-114d fails, there are still three power supplies available to share the load previously carried by the failed power supply. Thus, for instance, if the power supply 114c fails during operation, then the 25% of power previously provided to the power supply 114c may be equally redistributed among the remaining power supplies 114a, 114b and 114d (e.g., due to the current share pins housed within the power supplies).

The power connection 118 in the configuration shown in FIG. 1a is not coupled to the DCA 108 and thus carries substantially no current. That is, the power connection 118 of FIG. 1a is not used during operation. However, the power connection 118 of FIG. 2 carries a current during operation. Despite its lack of use, the power connection 118 of FIG. 1a is included in the system 100 for purposes of streamlining manufacture, thereby reducing production costs and increasing production efficiency. More specifically, by including power connection 118 in the system 100 of FIG. 1a, the embodiments of FIGS. 1a and 2 are made more similar, and because the embodiments of FIGS. 1a and 2 are made more similar, they can be manufactured using a substantially similar process.

Incorporating the power connection 118 into the system 100 also enables the system 100 to be adaptively used in single and multiple power grid infrastructures. Thus, for example, a consumer that has a dual power grid infrastructure may use an electronic device, such as a server, that has the dual power grid redundancy of system 100 instead of one that has the single power grid redundancy of system 199. However, the consumer may later decide to use the server in a single power grid infrastructure instead of the dual power grid infrastructure. In that case, the consumer may replace the DCA 108 of FIG. 1a with a jumper block and eliminate any unnecessary power supplies, thus producing the configuration shown in system 199 of FIG. 2.

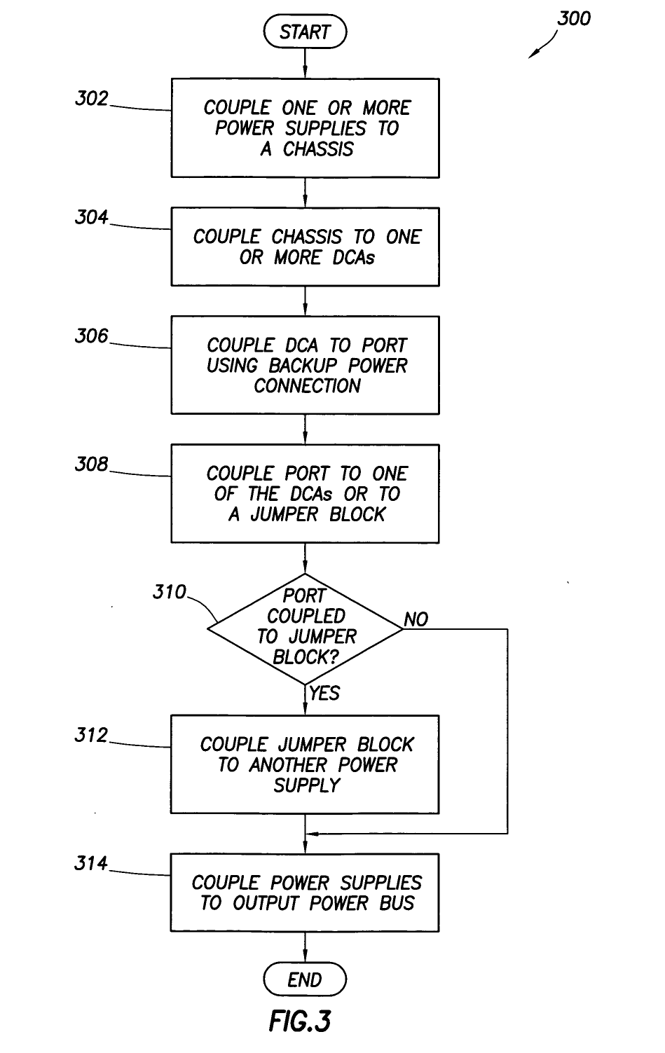

FIG. 3 shows a flow diagram of a method 300 that may be used to construct either of the systems 100, 199. Although the steps of method 300 are shown in a particular order, the scope of disclosure is not limited to performing the steps of method 300 in any specific order. Method 300 may begin with coupling one or more power supplies to a chassis (block 302), for example, a PCB. The chassis then is coupled to one or more DCAs (block 304), thus effectively coupling the power supplies to the DCAs via electrical connections on the chassis. As previously described, the DCAs receive power from power grids and allocate the power to the various power supplies. A backup power connection on the chassis, such as the backup power connection 118 in FIGS. 1a and 2, is coupled from one of the existing power connections on the chassis to a port (block 306). The port then is coupled to one of the DCAs or to a jumper block (block 308), depending on whether the system is implemented in a single power grid application or a multiple power grid application. In case a jumper block is coupled to the port (block 310), the jumper block is coupled to another power supply (block 312), thus establishing an electrical connection from the backup power connection to the power supply via the jumper block. The power supplies may then be coupled to an output power bus, such as the power bus 102 (block 314) or the power supplies may already be coupled to the output power bus. The chassis (e.g., the PCB) may be installed in a power distribution cabinet where the power supplies are coupled to the output power bus.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of power supplies coupled to a power grid via multiple connections; and
a connector coupled to one of said connections via a backup connection;
wherein, if the system receives power from no more than one power grid, the connector couples the backup connection to a backup power supply;
wherein, if the system receives power from multiple power grids, the backup connection does not carry a substantial electrical current.

2. The system of claim 1, wherein the system comprises a server.

3. The system of claim 1, wherein the power grid provides at least one of alternating current (AC) power or direct current (DC) power.

4. The system of claim 1, wherein the connector couples the backup connection to the backup power supply using a jumper block connector.

5. The system of claim 1, wherein the power grid comprises one of a three phase power line or a single phase power line.

6. The system of claim 1, wherein the system comprises fewer power supplies if the system receives power from no more than one power grid.

7. The system of claim 1, wherein, regardless of a number of power grids used by the system, the system is manufactured using a substantially uniform process.

8. A power chassis, comprising:
a plurality of connections, each connection coupling a different power supply to a power grid; and
a backup connection coupling one of said plurality of connections to a connector;
wherein, if at least some of the plurality of connections are coupled to different power grids, the backup connection does not carry a substantial electrical current;
wherein, if the plurality of connections are coupled to a single power grid, the connector couples the backup connection to a backup power supply.

9. The power chassis of claim 8, wherein the connector couples the backup connection to the backup power supply using a jumper block connector.

10. The power chassis of claim 8, wherein at least one power grid provides power selected from the group consisting of alternating current (AC) power and direct current (DC) power.

11. The power chassis of claim 8, wherein the power grid comprises one of a three phase power line or a one phase power line.

12. The power chassis of claim 8, wherein, if the power chassis receives power from different power grids, the backup connection carries no current.

13. A method for providing power redundancy to a system, comprising:
coupling a power supply to a power grid via a connection;
coupling the connection to a port using a backup connection;
if the system is a multiple power grid system, configuring the port such that the backup connection does not carry a substantial electrical current; and
if the system is a single power grid system, configuring the port such that the backup connection provides power from the power grid to a backup power supply.

14. The method of claim 13, wherein configuring the port comprises coupling the backup connection to the backup power supply using a jumper block coupled to the port.

15. The method of claim 13 further comprising providing power from the power grid to the power supply via said connection, wherein the power grid comprises one of a three phase power line or a one phase power line.

16. A system, comprising:
means for supplying power to an electronic device; and
means for transferring power from a power grid to the means for supplying power;
wherein, if the system receives power from no more than one power grid, the means for transferring power transfers power to the means for supplying power;
wherein, if the system receives power from multiple power grids, the means for transferring power does not carry a substantial current.

17. The system of claim 16, wherein, regardless of a number of power grids used by the system, the system is manufactured using a substantially uniform process.

18. The system of claim 16, wherein the means for transferring power comprises at least one of a wire or a jumper block.
